(19) United States
(12) Patent Application Publication
(10) Pub. No.: US 2015/0248730 A1
(43) Pub. Date: Sep. 3, 2015

(54) INSURANCE ADJUSTER CLAIM SCOPING

(71) Applicant: Pilot Catastrophe Services, Inc., Mobile, AL (US)

(72) Inventors: Curtis Frederick Pilot, Fairhope, AL (US); Colm M. Keenan, Middleton, WI (US)

(21) Appl. No.: 14/634,504

(22) Filed: Feb. 27, 2015

Related U.S. Application Data
(60) Provisional application No. 61/946,343, filed on Feb. 28, 2014.

(51) Int. Cl. G06Q 40/08; G06Q 10/06

(52) U.S. Cl. CPC G06Q 40/08; G06Q 10/0633

(57) ABSTRACT

An electronic insurance claim scoping method and system are configured to instantiate a scoping software application on a portable computing device used by an insurance claims adjuster. The portable computing device retrieves a record identifying an insurance claim assigned to the claims adjuster wherein the insurance claim is directed to damage to an improvement located on a subject real property. A scope record is presented on a display associated with the portable computing device, and first a plurality of entries of the scope record associated with the insurance claim is populated. From the claims adjuster, the portable computing device accepts user input associated with the subject real property that is associated with the insurance claim. A second plurality of entries of the scope record is populated with information based on user input from the claims adjuster, and the scope record is communicated to a remote computing server.

### BACKGROUND

1. Technical Field

The present disclosure generally relates to claim scoping systems and methods used by an insurance adjuster, and more particularly, but not exclusively, relates to generating a comprehensive workflow and presenting the workflow via a portable computing device to interactively guide the insurance adjuster through a claim scoping process.

2. Description of the Related Art

Insurance claims adjusters create reports based on their observations of property damage. The insurance adjuster will typically travel to the site of the calamity and record factual information pertaining to the loss.

For example, one case may involve a building roof allegedly damaged in a storm. The insurance adjuster will travel to the building, observe the visible roof damage, take measurements, and record additional information about the roof such as the roof's surface material, underlayment, roof decking, structural rafters, and the like. Depending on the type and cause of the damage, the adjuster may record additional information related to venting, chimneys, skylights, and other structures. The purpose of the insurance adjuster site visit is to record sufficient information for the insurance company to validate a claim made by the insured entity and estimate the scope of the claim.

The insurance adjusting process is expensive. Insurance adjusters must travel to the site of each property where damage is reported and take many measurements. Often, the measurements include length, width, and angle (e.g., roof pitch). Turning back to the roofing example, roof structures often include many compound angles formed by peaks and valleys of intersecting faces of the roof, gables, dormers, chimneys, vents, skylights, and the like. Reducing the time to safely observe and accurately measure the roof can make an insurance adjuster more efficient and thereby less expensive.

### BRIEF SUMMARY

Insurance adjusters perform claim scoping procedures and produce loss information reports. The loss information reports are used to estimate the financial cost to repair or replace damaged property. In the present disclosure, a new claim scoping system is described, which increases the efficiency of performing a claim scoping process. In addition, the new claim scoping system also leads to increased accuracy of a loss information report.

Within the new claim scoping system, a claims adjuster carries a portable computing device (e.g., a tablet computer, a mobile “web pad,” or the like). A plurality of nodes organized as a workflow is presented as a flowchart on a display of the portable computing device. The nodes direct the actions of the claims adjuster before, during, and after the claims adjuster visits the site of the loss that is the subject of the insurance claim. Upon capturing information related to the loss as directed by the workflow flowchart, the information is stored in a loss information report. Data from the loss information report is presented to an estimating system, which automatically estimates the insurance claim.

An electronic insurance claim scoping system may be summarized as including: a processor; an input/output interface coupled to the processor and configured to accept data for processing by the processor and configured to communicate data processed by the processor; and a memory associated with the processor, the memory including software instructions executable by the processor, the software instructions arranged to direct operations of the electronic insurance claim scoping system via a plurality of modules, the operations including: receiving insurance claim assignments from a first external system; for each received insurance claim assignment, checking a second external system for availability of property-specific information associated with the respective received insurance claim assignment; automatically downloading available property specification information; accepting an adjuster log-in from a remote device associated with the adjuster; selecting an insurance claim assigned to the logged-in adjuster; communicating information associated with the selected insurance claim to the remote device associated with the adjuster; accepting a loss information report associated with the selected insurance claim, the loss information formed via a scoping application executed on the remote device associated with the adjuster; the plurality of modules including: a user management module, the user management module configured to manage individual users of the electronic insurance claim scoping system, the individual users organizable into a plurality of user permission groups; and a dashboard module, the dashboard module configured to display information to a first user of the electronic insurance claim scoping system based on a membership designation of the first user in at least one of the plurality of user permission groups.

The plurality of modules may further include: a location services module, the location services module configured to: receive geographic location information from the remote device associated with the logged-in adjuster; and automatically locate an insurance claim number of an insurance claim associated with the geographic location information. The location services module may further be configured to: automatically locate a map of an area associated with the geographic location information. The location services module may further be configured to: associate the geographic location information with information received from the remote device associated with the logged-in adjuster. The plurality of modules may further include: a workflow generation module, the workflow generation module configured to generate a workflow associated with the selected insurance claim, the workflow displayable as a flowchart having a plurality of node objects coupled together by a plurality of connectors, the workflow configured to direct the logged-in adjuster to perform actions associated with the selected insurance claim. At least some of the plurality of node objects of the workflow may be configured to store data linked to the respective node object. The workflow generation module configured to generate the workflow associated with the selected insurance claim may further be configured to: present a flowchart-based interface; permit the first user to select at least two node objects from a pool of template node objects, the pool of template node objects including: a label node object configurable to present an instruction; a Boolean node object configurable to identify an available plurality of next node objects, a selection of a next node object based on at least one Boolean condition; a numeric answer node object, the numeric answer node object configurable to accept numeric nodal user input; and a text answer node object, the text answer node object configurable to accept textual nodal user input. The pool of template node objects may further include: an audio answer node object, the audio answer node object configurable to accept audio nodal user input; and a take-photo node object, the take-photo node object configurable to present a prompt to a user of the remote device, the prompt requesting a digital image nodal input, the take-photo node object further configurable to accept a digital image. The pool of template node objects may further include: a list of values node object, the list of values node object configurable to present a drop down list and further configurable to accept drop down list selection nodal user input; a measurement node object, the measurement node object configurable to accept measurement nodal user input, the measurement nodal user input conforming to a selected units of measure; and a load material list node object, the load material list node object configurable to present a list of materials and further configurable to accept list selection nodal user input, the list selection nodal user input identifying at least one material on the load material list.

A non-transitory computer readable medium having computer executable instructions thereon that, when executed, cause a processor to create, control, or manage an insurance claim workflow may be summarized as including: presenting a flowchart-based interface; accepting user input selecting at least two node objects from a pool of template node objects, the pool of template node objects including: a label node object configurable to present an instruction; a Boolean node object configurable to identify an available plurality of next node objects, a selection of a next node object based on at least one Boolean condition; a numeric answer node object, the numeric answer node object configurable to accept numeric nodal user input; and a text answer node object, the text answer node object configurable to accept textual nodal user input; accepting user input positioning the selected node objects on a workspace; accepting user input associating presentable information with at least one of the selected node objects, the presentable information linked to the selected node object and presentable when the insurance claim workflow is displayed; accepting user input coupling a plurality of nodes via at least one connector object; displaying the insurance claim workflow as a flowchart having the at least two selected node objects coupled via the at least one accepted connector object; and associating the insurance claim workflow with an insurance claim record.

The pool of template node objects may further include: an audio answer node object, the audio answer node object configurable to accept audio nodal user input; a take-photo node object, the take-photo node object configurable to present a prompt to a user, the prompt requesting a digital image nodal input, the take-photo node object further configurable to accept a digital image; a list of values node object, the list of values node object configurable to present a drop down list and further configurable to accept drop down list selection nodal user input; a measurement node object, the measurement node object configurable to accept measurement nodal user input, the measurement nodal user input conforming to a selected units of measure; and a load material list node object, the load material list node object configurable to present a list of materials and further configurable to accept list selection nodal user input, the list selection nodal user input identifying at least one material on the load material list. The non-transitory computer readable medium having computer executable instructions thereon that, when executed, cause the processor to create, control, or manage the insurance claim workflow may further include: communicating the insurance claim workflow to a remote computing device; receiving an updated insurance claim workflow from the remote computing device, the updated insurance claim workflow having information linked to at least one of the selected node objects; and processing the linked information.

An electronic insurance claim scoping method may be summarized as including: instantiating a scoping software application on a portable computing device; retrieving a record identifying an insurance claim assigned to a first user of the portable computing device wherein the insurance claim is directed to damage to an improvement located on a subject real property; retrieving a workflow associated with the record, the workflow displayable as a flowchart having a plurality of node objects coupled together by a plurality of connectors, the workflow configured to direct the first user to perform actions associated with the insurance claim; populating a first plurality of entries of the workflow; displaying on a display device of the portable computing device at least a portion of the workflow; accepting workflow user input, the workflow user input configured to identify a node object of the workflow; accepting nodal user input, the nodal user input including information regarding the subject real property; linking the nodal user input with the identified node object; and communicating the workflow to a remote computing server.

The method may include: authenticating the first user of the portable computing device based on an insurance adjuster identification record. The method may include: generating a scripted voice prompt with a speech synthesis engine, the scripted voice prompt corresponding to an audio answer node object of the workflow, the scripted voice prompt requesting information from the first user; and playing the scripted voice prompt via an audio output apparatus of the portable computing device. The scripted voice prompt may be generated according to a stored template. The method may include: generating scripted voice prompts with a speech synthesis engine, the scripted voice prompts corresponding to an audio answer node object of the workflow, the voice prompts requesting information from the first user; and accepting additional nodal user input in response to the scripted voice prompt, the additional nodal user input including at least one of: audio input captured with an audio input apparatus of the portable computing device, electronic image input captured with a camera apparatus of the portable computing device, and text input captured with a text input apparatus of the portable computing device. The method may include: importing at least one electronic image file, the electronic image file representing a digital image of at least some portion of the property; passing the at least one electronic image file to a display device associated with the portable computing device; and linking the at least one electronic image file to the identified node object of the workflow. The plurality of node objects may be selected from a pool of node objects, the pool comprising: a label node object configured to present an instruction and further configured to not accept nodal user input; a Boolean node object configured to identify an available plurality of next node objects, a selected next node object based on at least one Boolean condition; a numeric answer node object, the numeric answer node object configured to accept numeric nodal user input; a text answer node object, the text answer node object configured to accept textual nodal user input; an audio answer node object, the audio answer node object configured to accept audio nodal user input; a list of values node object, the list of values node object configured to present a drop down list and further configured to accept drop down list selection nodal user input; a measurement node object, the measurement node object configured to accept measurement nodal user input, the measurement nodal user input conforming to a selected units of measure; a load material list node object, the load material list node object configured to present a list of materials and further configured to accept list selection nodal user input, the list selection nodal user input identifying at least one material on the load material list; and a take-photo node object, the take-photo node object configured to present a prompt to a user of the portable computing device, the prompt requesting a digital image nodal input, the take-photo node object further configured to accept a digital image. The method may include: performing an automated cost estimate based on the workflow.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is a flow diagram illustrating acts of a process embodiment to assign an insurance claim, scope the claim, and prepare a loss information report;

FIG. 2 illustrates an insurance processing core system configured to carry out function(s?) represented in a claim flow diagram;

FIG. 3 illustrates a user interface block diagram for a workflow generation module;

FIG. 4 is a flowchart illustrating generation of an insurance claim workflow; and

FIG. 5 is an embodiment of an electronic insurance claim information report generation system.

### DETAILED DESCRIPTION

The conventional methodology used by insurance adjusters to generate electronic insurance claim reports is now made more efficient with a new insurance claim scoping system that delivers a comprehensive, interactive workflow via a portable computing device. Using the new system, an insurance adjuster will typically still visit the site of the calamity. The personal visit reduces the likelihood of fraud, increases accuracy, and provides other benefits. Now, however, the activities of the insurance adjuster are directed more efficiently than in the in past.

The new claim scoping system comprises a computing-server-based core system and a portable-computing-device-based mobile application. The new claim scoping system allows claim adjusters to scope different types of property damage from the site of the damage, and the new system automatically sends a loss information report to a computing-server-based estimating system.

Generally speaking, the new claim scoping system includes a plurality of identifiable acts performed individually or cooperatively by multiple computing devices. In a first act, a core system receives an insurance claim record from a claims processing computing server. The claims processing computing server, which is administered by an insurance entity, manages claims and interactions between insured parties and people, processes, information, technology, and other systems of the insurance entity.

Next, the core system of the new claim scoping system assigns the insurance claim to an insurance claim adjuster. If the insurance claim meets certain criteria, third-party information associated with the claim is retrieved and electronically “attached” to the insurance claim record. The core system then constructs a claim scoping workflow for the insurance claim.

On a portable computing device, an insurance claim adjuster assigned to the insurance claim retrieves information prepared by the core system, including the claim scoping workflow. In many cases, the workflow is pre-populated with known information related to the insurance claim. The assigned claim adjuster visits the site of the loss and follows prompts presented by the workflow on the portable computing device to enter additional information related to the loss. Once the claim scoping process workflow is complete, the information is sent to another computing server device for estimating. Relevant information is also returned to the claims processing computing server.

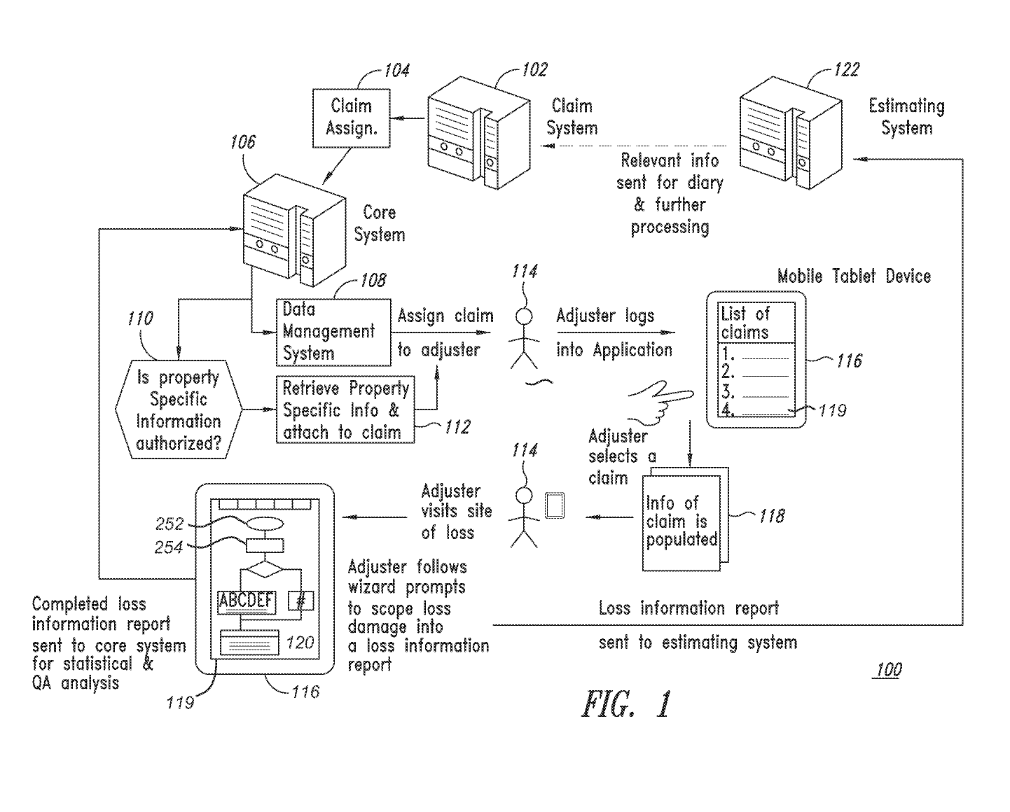

FIG. 1 is a flow diagram illustrating acts of a process embodiment to assign an insurance claim, scope the claim, and prepare at least one loss information report. The acts are performed with hardware and software of a new claim scoping system 100, which includes various computing devices to particularly and specifically receive, act on, and generate data to more efficiently direct claims adjusters in their work.

A claim processing system 102 functions to manage a plurality of insurance claims. In many cases, the claim processing system 102 is a computing server executing software to carry out the plurality of management functions. One or more databases are embedded within or otherwise accessible to the claim processing system 102.

For example, one database may store and edit information related to employees and other workers associated with an insurance company (e.g., including claims adjusters). Another database may store information associated with parties insured by the insurance company. The information associated with the insured parties can include insurance policy documents, claims history, property addresses, details related to insured structures, and the like. Yet one more database may store information directed to material costs, details of construction, contractor costs, approved contractor lists, and the like.

Still one more database may store information associated with claims made to the insurance company. The claims may include active claims, pending claims, closed, claims, and other types of claim information.

In a particular embodiment discussed in conjunction with FIG. 1, an accident causes damage to a property insured by a particular insurance company. The insurance company operates the claim processing system 102. In response to a claim filed with the insurance company, a new claim record is added to a claims database accessible by claim system 102. The new claim record represents an active claim to be processed by the insurance company. The new claim record stores a variety of information related to the claim.

At 104, the claim is passed to a claim scoping core system 106. A claim scoping core system 106 manages the processing of the insurance claim by a claims adjuster. When a new claim is passed to the claim scoping core system 106, several processes are initiated to prepare the claim for processing.

A data management system module 108 will prepare template forms associated with the claim and populate the forms with known information regarding the claim. Examples of known information include the property address where the loss occurred, known information captured when the claim was submitted, the name and policy number of the insured party, contact information for the insured party, contact information used by a claims adjuster to access the damaged property, and more.

In addition to preparing template forms, the data management system module 108 will also generate a workflow for the specific claim. The workflow will be followed by service providers such as claims adjusters or inspectors to capture information associated with the insurance claim.

In a concurrent process, the claim scoping core system 106 will initiate a process to determine if third-party property-specific [done without redlining from here] information is available and authorized. For example, it is known that some third-party companies provide information related to structures present at specific property addresses. Other third-party companies provide information related to different aspects of specific property addresses.

In one case, third-party companies use aerial photographs (e.g., satellite imagery) of large areas of land. These companies process the photographic images to apply property boundaries and property addresses. The companies further process the photographic images to identify individual structures on the property. And the companies still further process the photographic images to identify specific details about the individual structures. In some cases, the third-party companies will deliver, for a fee, electronic documentation that includes the specific details, such as roof measurements, roof materials, angles, 3D modeling, and the like. If an insurance claim is directed to a damaged roof, then such a third-party report may be useful to the insurance company. That is, even though the same information may be gathered by an insurance adjuster who visits the site of the damaged property, it is less expensive to purchase a report and validate the information than it is to have the claims adjuster capture the information from scratch. With reference to FIG. 1, the property-specific information is retrieved and attached to the claim record in another process 112.

In a second case, third-party companies gather information from public records such as information associated with property taxes, information associated with granted or denied permits, information associated with zoning classifications, information reported in local newspapers or Internet websites.

In still other cases, third-party companies may provide other information related to a specific property address. When this information is useful to process an insurance claim, and when this information is more efficiently gathered from a third-party, the acquisition of the information may be authorized in the process 110 and retrieved in another process 112.

In a subsequent act, the insurance claim is assigned to a claims adjuster 114. The claims adjuster 114 carries a portable computing device 116. The portable computing device 116 is loaded with a claim scoping application 119 that administers at least one workflow for each insurance claim. The claims adjuster 114 executes the claim scoping application 119 on the portable computing device 116.

When the claim scoping application 119 begins running, the claims adjuster 114 will log into the claim scoping application 119 using personal credentials. The claim scoping application 119 will provide the claims adjuster 114 with an opportunity to select an assigned claim. When a claim is selected, at 118, information regarding the selected claim is populated in various fields of various forms of a loss information report associated with the selected claim. The information automatically populated in the loss information report includes the information gathered and processed by the data management system module 108. Some or all of the information in the forms is displayable on the portable computing device 116.

The claims adjuster 114 will bring the portable computing device 116 to the site of the loss. At the loss site, the claims adjuster 114 will view the damage that is the subject of the selected insurance claim. A user interface embodiment of the workflow 120 will be displayed by the claim scoping application 119 running on the portable computing device 116.

The user interface embodiment of the workflow 120 directs the actions of the claims adjuster 114 with respect to the loss. For example, the claim scoping application 119 presents a series of prompts (e.g., a software wizard) that request information from the claims adjuster 114. In some cases, the information may be measurements or other numerical data which the claims adjuster 114 provides or confirms. In other cases, the information may be text information such as an observational narrative of the damage. In still other cases, the claim scoping application 119 may direct the claims adjuster 114 to take one or more photographs, render one or more sketches, provide audio input, or enter some other type of information.

As the claims adjuster 114 progresses through the workflow, information entered into the portable computing device is used to further populate the loss information report associated with the selected insurance claim. At some point, the claims adjuster 114 reaches the end of the workflow. The end of the workflow may be arrived at by following sequential prompts. Alternatively, the claims adjuster 114 may start various aspects of the workflow, suspend them while other tasks are addressed, and return to the suspended portions at a later time. At some point, all directives from the workflow are satisfied, or the claims adjuster 114 determines that no further information will be entered, and the workflow is deemed complete. Completion of the workflow causes the loss information report to be deemed complete.

At some point, the completed loss information report is communicated back to the core system 106 and also to an estimating system 122. The loss information report sent to the core system 106 may or may not be the same loss information report sent to the estimating system 122. That is, a first loss information report may be sent to the core system 106, and the first loss information report typically includes all information associated with the underlying insurance claim such as video notes, audio narratives, sketches, and other data generated by the claims adjuster 114. A second loss information report may include a subset of data from the first loss information report. The second loss information report, which is sent to the estimating system 122, is typically limited to including only information useful to the estimating system 122. In one embodiment, the first loss information report includes a portable document format (PDF) report prepared in an easy-to-read format. In one embodiment, the second loss information report includes an extensible markup language (XML) format report and associated multimedia files.

Within the core system 106, the loss information report (e.g., a first loss information report) may be analyzed. Statistical data may be produced from the analysis, and quality assurance information may be produced from the analysis. In certain cases, some or all of the statistical information and some or all of the quality assurance information is passed back to the claim system 102.

The estimating system 122 retrieves data from the loss information report (e.g., a second loss information report) and estimates the cost to remediate the loss. The remediation cost is in some cases a comprehensive complete cost for total remediation. Alternatively, or in addition, the cost may be broken out at a desired level of detail. Relevant information from the cost estimation is passed to the claim processing system 102. In some cases, some or all of the information from the first or second loss information report is passed to the claim processing system 102.

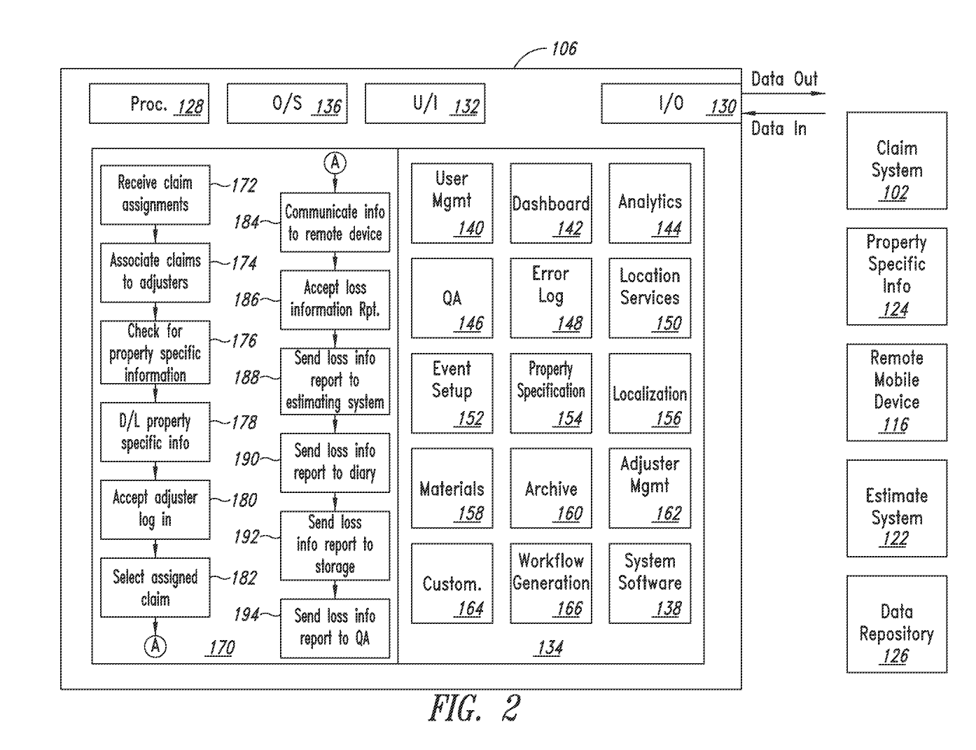

FIG. 2 illustrates an insurance processing core system 106 configured to carry out functions represented in a claim flow diagram 170. The core system 106 administers the new claim scoping system described in embodiments herein. That is, the core system 106 receives insurance claim information from an insurance company controlled claim system, generates data for loss information reports, communicates with claims adjusters either directly or via a claim scoping application executing on a portable computing device, and communicates claim scope information to an estimating system. The core system 106 may also communicate data back to the insurance company controlled claim system and communicated with other computing devices such as third-party property-specific information servers, data repositories, and the like.

Core system 106 is a computing server device having hardware modules and software modules. The hardware modules of the core system 106 include a processor 128, input/output (I/O) ports 130, a user interface 132, and memory 134. The software modules include an operating system 136, system software 138, a user management module 140, a dashboard module 142, an analytics module 144, a quality assurance (QA) module 146, an error log module 148, a location services module 150, an event setup module 152, a property specification module 154, a localization module 156, a materials module 158, an archive module 160, an adjuster management module 162, a company customization module 164, and a workflow generation module 166.

The core system 106 is configured to communicate with several devices including the claim processing system 102, one or more remote devices 116, the estimating system 122, a third-party property-specific information computing server 124, and a data repository 126.

The operating system 136 directs operations of software modules in the core system 106. Typically, though not exclusively, the operating system 136 is a multitasking operating system that concurrently executes software instructions of several software modules. The operating system 136 may or may not reside in memory 134. That is, in some cases, the operating system 136 operates in a separate memory from other software modules.

The operating system 136 is complemented by system software 138, which provides a range of user interactive and system support functionality. The system software 138 includes device drivers and middleware to pass data between the operating system 136 and various modules (e.g., UI module 132, I/O module 130, dashboard module 142, and the like). The system software 138 may also include high level programs such as a word processing programs, graphics entry and modification programs, spreadsheet programs, and other programs having desirable user functionality.

Operations within the core system 106 are controlled and directed by a variety of users including claims adjusters, supervisors, technical support personnel, and others. A user management module 140 monitors and controls activities of users of the claim scoping system. The user management module 140 allows for the dynamic creation, editing, and deletion of users of the new claim scoping system. When a new user is created, the user management module 140 creates a record in a user database. A set of default permissions based on the user's position or job description is applied; however, the permissions can be edited. In this way, custom permission sets may be created to grant access to core system services for different types of users.

For example, some user types may include Super User Administrators, Managers, Event Administrators, Quality Control users, and Support personnel. Super User Administrators are granted permissions to access and edit any information stored in the core system 106 or otherwise accessible. Managers are typically granted permission to see and edit any information of the core system 106 associated with personnel that reports to the manager. In this way, various levels of access privileges (i.e., permissions) may be stacked and treated in a hierarchy. Claims adjusters are generally granted Event Administrator privileges. Claims adjusters and others with such privileges have credentials to add and edit information associated with their own account, but generally, these users cannot access information associated with other users. In some cases, the Event Administrator users are permitted to delete data, but in other cases, they are not. In some embodiments, users with Quality Control (QC) privileges can view data associated with all Event Administrator users, but QC users are not permitted to delete data. Along these lines, users with Support personnel privileges can access some data, but not other data. For example, Support personnel may be permitted to add, delete, and edit data specifically related to operations of the core system 106, but these users may not be permitted to view data associated with any insurance claims.

The core system 106 includes a dashboard module 142. The dashboard module 142 presents information to users of the core system via the user interface 132, and the displayed information is updated dynamically. The information presented by the dashboard module 142 is most often related to insurance claims currently in process or previously processed through the core system 106. Other information may be related to claims adjusters or other personnel, system resources, other network-accessible resources, and the like. The dashboard module 142 can tailor its output to privilege attributes of a user. A display set of live, relevant information is available for presentation by default, and the display set can be customized by the user.

In one embodiment, the dashboard module includes default display sets for users having different privilege attributes. A Super User Administrator may be able to display full statistics of any claim flow in the claim scoping application. The Super User Administrator may also have access to the core system 106 operational or “up” status at any given moment or over any given period of time. The Super User Administrator privileges may further grant access to system error alerts.

In the embodiment, a user with Manager privileges will have access to certain filtered data. For example, the Manager-privileged user typically is only able to present information associated with claims adjusters that report to the manager and events associated with the subordinate claims adjusters. The user with Manager privileges can see statistics corresponding to the status of one or more claims, and the user can sort the information in many ways. The user with Manager privileges may also configure the dashboard module 142 to present claims adjuster override alerts, out of compliance claim alerts, pending replied notes, performance information of each subordinate claims adjuster, and other information.

Also in the embodiment, a user with Event Administrator privileges (such as a claims adjuster) directs information that is presentable with the dashboard module 142. The information presented may include data that is filtered per event, statistics of claim status per event, and performance statistics per event.

An analytics module 144 is configured to provide an overview of usage of the claim scoping application. The analytics module is configured to retrieve information from one or more databases and generate various reports. The reports can be filtered per date range or by other criteria and exported for further analysis. In one embodiment the analytics module 144 produces Overview reports, Detail reports, and Quality Assurance (QA) reports. In other embodiments, different reports may also be produced.

Overview reports produced by the analytics module 144 provide system-wide information. For example, the overview reports may include a number of claim scopes processed and details regarding the processed claims, third-party property-specific information files downloaded, sketches drawn, pictures uploaded, videos uploaded, total users, voice-activated database diary entries submitted, help desk tickets submitted, demographics, location usage, and other information. The reports may include information associated with any of the system-wide categories of information. Alternatively, or in addition, the overview reports may include links or other identifying references to the system-wide categories of information.

Detail reports produced by the analytics module 144 may provide information at variable levels of granularity. That is, the detail reports can be customized to provide large volumes of very specific data, or lesser volumes of a subset of the available specific data. One example of information available in a detail report is Internet speeds on submission of loss information reports from portable computing devices of on-site claims adjusters. Such reports track network availability and data upload and download speeds, usage and availability of network protocol (e.g., 3G or WiFi) per location. Another example of information available in a detail report is time associated per insurance claim scoping workflow. The detail report may include system wide average information, user average information, specific claim time information, and other information. Detail reports may also include information such as total number of claim scoping workflows processed per user and location, total number of sketches entered per user and location, total number of pictures taken and entered per user and location, total number of videos per user and location, total number of diary entries per user and location, and other information. The detail report may include further details or reference links to any of the system-wide parameters.

Quality Assurance (QA) reports produced by the analytics module 144 present details useful for validating the efficiency of the core system 106 and for identifying areas of potential improvement. QA reports can present scores rating individual claims adjusters, loss information reports generated with or without errors, “best” and “worst” scores, and other criteria. The QA report can identify specific areas of improvement in claim scoping workflows, loss information reports, sketches, videos, manually typed entries, measurements, and others. The QA reports may be prepared to provide report details per claims adjuster, event average score, score per “loss type,” score based on complexity level, and other criteria.

A Quality Assurance (QA) module 146 allows interaction with certain users of the core system 106. The certain users, for example those with Super User Administrator privileges and those with Manager privileges, may be granted permission to execute functions of the QA module. The functions operate to “grade” claim scoping workflows based on their complexity. In some embodiments, the permitted users can search for particular insurance claim records by claim number, event, claims adjuster, location, date range, or some other criteria. Once identified, the user can set a claim scoping workflow complexity level and a “score” for the claim scoping workflow such as a numerical scale that permits comparison of one workflow to another. In some cases, the user can also add notes to a record associated with the score. Certain data, such as the score, may be accessed by the core system 106 and used as criteria to assign the claim to a claims adjuster 114 having an appropriate skill level or training background to perform well when completing the claim scoping workflow. Data may also be communicated back to a claim processing system 102.

An error log module 148 captures errors associated with various aspects of the core system 106. In some cases, the error log module 148 merely receives error reports and post processes the data. In other cases, the error log module 148 may be configured to detect errors that occur within the new claim scoping system. Errors may include such issues as mismatched claim numbers, invalid property addresses, misspellings, incorrect dollar values, computing device hardware and software failures, and many others. The error log module 148 stores details related to each error such as a time stamp and a trace log. The error log module 148 may also generate reports to present error information to privileged users and send reports to outside systems, for example claim processing system 102.

The location services module 150 provides location-based services to the new claim scoping system. Embodiments of the location services module 150 provide geographic data for each insurance claim that is processed by the core system 106. For example, when the site of the loss is processed, the location services module 150 may automatically retrieve map data of the site. The map data may be locally stored in a database accessible by the core system 106. The map data may also include notes provided by users of the core system 106, photographs, audio data such as a narrative provided by a claims adjuster 114, and other data personally entered and specific to the site of the loss.

In addition, or alternatively, the map data used in the location services module 150 may be retrieved from a third party. Examples of sources that provide third-party mapping data are websites that present satellite imagery and correlated address information via the Internet.

In other embodiments, portable computing devices 116 of claims adjusters provide data for the location services module 150. For example, a claim scoping application 119 running on the portable computing device 116 may “track” the associated claims adjuster 114 by providing positional information from a global position system (GPS) on board the portable computing device 116. In these cases, the location services module 150 can “pull” the location of the claims adjuster 114 based on the provided GPS data. For example, if a user with Manager privileges wants to know the current physical location of a subordinate claims adjuster 114, the user may interact with the core system 106 via the dashboard module 142, and learn the location. The dashboard module 142 may display a map with a highlighted beacon or other identifier illustrating the claims adjuster's location. Alternatively, the dashboard module 142 may post a nearby address of the claims adjuster's location. In some cases the location services module 150 may interrogate a certain claims adjuster's portable computing device 116 to learn the positional information. In other cases, the portable computing device 116 may automatically provide the GPS with other positional information.

In some embodiments, other services are administered by the location services module 150. For example, when a claims adjuster 114 travels to a loss site, the claim scoping application 119 may provide positional information (e.g., GPS data). The positional information may be used in cooperation with the location services module 150 to identify the insurance claim that corresponds to the current location. This feature provides a convenience to a claims adjuster 114 by automatically populating a workflow with relevant data so that the claims adjuster 114 can efficiently progress through the claim scoping process. The location services module 150 may provide further features such as the “bird-eye-view” maps, which can be incorporated into a workflow. In addition, the location services module 150 may be used to provide latitude and longitude, street address, or other geographic position information for pictures, videos, sketches, audio recordings, scoping data files, and the like.

An event setup module 152 administers “events” in the new claim scoping system. An event represents a task, an alert, a function, or another like operation that will be processed by either the core system 106 or the portable computing device 116. Once created, an event can be modified and then deleted. Modifications to the event are typically made when, for example, the claim scoping application 119 takes action on the event, even if the underlying operation is not yet complete.

In one example, an event is created by the core system 106 to request information from a third-party property-specific information computing server 124 pertaining to a certain insurance claim. Subsequently, when the underlying insurance claim is scoped, a request is made to the third-party property-specific information computing server to request delivery of particular information. When the request is made, by either the core system 106 or the portable computing device 116, the event may be updated. Later still, when the request is satisfied and the third-party property-specific information is delivered, the event can be updated again.

In another example, the claims adjuster 114 may create an event to request third-party property-specific information. Based on the request, an alert may be set, which is directed to one or more users having Manager privileges. Upon receiving the alert, a user with the appropriate privileges may accept the request and authorize collection of the third-party property-specific information. Alternatively, the user having Manager privileges may deny the request or alter the request such that the property-specific information is retrieved from a different source than the requested third party.

The event setup module 152 may create events to be globally accessible. That is, events may be viewable via the dashboard module 142 based privileges of a particular user. Events may also be viewable via a portable computing device 116. As events are created and modified by users, the event setup module 152 will validate the information associated with the event with criteria such as a proper time and day and an authorized provider or actor for the event. The event setup module 152 may in some cases process a newly created event to verify that an event requesting the same underlying operation is not already entered.

A property specification module 154 operates to collect and administer information about the property that sustained a loss. One or more property-specific databases may be used to store the property-specific information. In some cases, the property specification module 154 operates as a conduit to request and to receive third-party property-specific information. In some cases, the property specification module 154 retrieves property-specific information from other sources such as the claim processing system 102. In still other cases, the property specification module 154 collects and processes property-specific information produced by a claims adjuster 114 using the claim scoping application 119 at the site of a loss.

In a case where the property specification module 154 operates as a conduit to request and to receive property-specific information from a third party, certain account information to access the third-party services may be stored or otherwise available to the property specification module 154. If authorized, for example by an event from the event setup module 152, the property specification module 154 will request the information from the third party. The request may include criteria drawn from the event record or the request may include other criteria customizable by a user. The criteria may include a list of property-specific information reports used per event, a scheduled date and time of the property-specific information report download, the claim number, an identification number of the claims adjuster 114, and other information.

When property-specific information is retrieved, the retrieved information will be stored in the one or more property-specific databases by the property specification module 154. The stored data may be presented by the dashboard module 142 to a properly credentialed user. The stored data may further be presented to other systems such as the claim processing system 102.

The localization module 156 is included in the core system 106 to address different geographically based rules (i.e., regulations, laws, statutes, ordinances, orders, guides, restrictions, precepts, directions, standards, and the like). Some states have certain rules that other states do not. Similarly, some counties, cities, towns, zip codes, or other jurisdictions have rules that other jurisdictions do not. The localization module 156 typically applies a default set of rules when an insurance claim record is received by the core system 106. Then, based on information from the location services module 150, the localization module 156 may apply specific geographically-based rules.

The geographically-based rules applied by the localization module 156 may include accessories associated with a property loss, approved materials to perform repairs, while un-approved materials are removed or otherwise indicated to be unavailable, any permits required along with contact and other relevant information, and other such rules. In some cases, rule-change information is also made available in the insurance claim record to provide useful information to the claims adjuster.

The geographically based rules applied by the localization module 156 are generally reflected in a workflow presented by a claim scoping application 119 executing on the claims adjuster's portable computing device 116. In some embodiments, certain rules will manifest as a choice for a claims adjuster 114. For example, when scoping property damage, such as a roof, the claims adjuster 114 may have a choice of replacement materials. In the workflow presented on the portable computing device 116, a choice of materials will be listed, and the entries on the list will have been directed by the localization module 156. For example, roofing materials that are prohibited in the jurisdiction may not show up on the list or may show up as “greyed out” and unavailable to be selected. Roofing materials that are most often used may show up at the top of the list. Other customizations to improve efficiency are also applied. In another embodiment, the claims adjuster 114 at the same site now exemplified may learn that a neighborhood covenant prohibits certain colors of roof shingles. In this case, the claim scoping application 119 may allow the claims adjuster 114 to input information (e.g., text or audio) acknowledging the previously unknown rule, the new rule will be communicated back to the localization module 156. The localization module 156 will receive the new rule, validate the new rule, conform the new rule to an acceptable format, and apply the new rule to future insurance claims of the same type and in the same jurisdiction.

The materials module 158 will operate in conjunction with a localization module 156. The materials module 158 will analyze information in the insurance claim record to first identify a default set of materials related to the loss. The set of materials may be chosen based on identifier codes for the type of damage entered, keywords in a description of the damage, or audio data recorded in association with the insurance claim. Other techniques and data may also be used to select a default set of materials for the insurance claim.

The materials module 158 supplies data that will be presented in the workflow on a portable computing device 116 to a claims adjuster 114. The materials data presented to the claims adjuster 114 may include photographs, manufacturer reference numbers, product identifier numbers, a name and description of the material, a price or price range of the material, and other information. The localization module 156 may provide direction as to the presentation of the materials in the workflow. For example, more common materials, or materials used most often for other reasons, will generally be presented in a more prominent position on the portable computing device 116 than other materials.

Operations of the archive module 160 within the core system 106 prepare and store insurance claim information. The archive module 160 administers one or more archive databases for the information. Generally speaking, the archive database records are searchable in many ways, and the information within the archive database records is linked in many ways.

The product of the new claim scoping system is referenced herein as a loss information report. The loss information report may comprise textual information, numeric information, cost or other financial information, photographic information, video information, audio information, government record information, historic insurance information, ownership information, injured party information, and still other information associated with an insurance claim. The information of the loss information report is represented as digital information readable by a computing device. Accordingly, the information may be stored in the archive database records as one or more records linked in a searchable, useful way. In some cases, the non-textual information may include record fields that permit the addition of textual or numeric commentary. For example, video data may be stored with additional textual or numeric coding or commentary that identifies the subject matter of the video data. The added information may include the loss type, claims adjuster, event data, location, score, estimated cost, a narrative of what is represented in the video data, and other information.

The archive module 160 may include an interface through the dashboard module 142. Based on a user's privileges, the archive database records may be searched in useful ways. For example, a loss information report (i.e., a “full scope”) and all of its associated database records may be searched based on loss type, score, claims adjuster, event, location, estimated cost, or by some other criteria. In this way, links to relevant video, audio, text, cost information, and other records may be identified and retrieved.

In some cases, the archive module 160 is searched for material useful to train new insurance personnel. In some cases, the archive module 160 automatically purges old data or other data directed for deletion by certain rules (e.g., personal identification information).

An adjuster management module 162 is configured to create and maintain records associated with each claims adjuster that accesses the new claim scoping system. Based on a user's privileges, the user can create, retrieve, edit, and delete information related to the claims adjuster via the adjuster management module 162. For example, a supervisor may have Manager privileges to access records related to some or all of the claims adjusters. The privileges may be customized to each particular claims adjuster. For example, the supervisor may be able to retrieve a limited amount of information on every claims adjuster, and the supervisor may be able to edit or delete certain information for each subordinate claims adjuster. Users with Super User Administrator privileges may be able to access all of the claims adjuster records without restrictions. Typically, the adjuster management module 162 will maintain a log of all accesses and all modifications to the claims adjuster records.

The adjuster management module 162 may work cooperatively with the dashboard module 142 to display claims adjuster information to an appropriately privileged user. The adjuster management module 162 may, for example, permit a user to search for claims adjusters and filter them by an “active” or “inactive” statue. The adjuster management module 162 allows access to information that may include account information such as an employee identification number, logon credentials such as a username and password, a list of completed claim scopes, a list of pending claim scopes, usage statistics, learning management system (LMS) training, claims adjuster score, and other information.

The new claim scoping system may be used by one or more insurance companies. That is, as illustrated and described, the claim scoping core system 106 is communicatively coupled to a single claim processing system 102, but it is recognized that the core system 106 may be coupled to two or more claim processing systems 102. Particular identifier information is used in the new claim scoping system to flexibly and securely isolate the records of one insurance company from another insurance company.

A company customization module 164 is configured to maintain the operations between the core system 106 and associated portable computing devices 116 of each insurance company. Computing resources are shared between the tasks of one insurance company and the tasks of another insurance company, and the tasks and use of the resources can be customized for each insurance company.

The company customization module 164 can customize data and operations for several companies. For brevity, an example may consider a first insurance company and a separate and distinct second insurance company. In this example, the company customization module 164 can direct the output of a workflow (i.e., loss information report data) to a first insurance company's estimating system 122 or a second insurance company's estimating system 122, respectively. The company customization module 164 can provide separate and secure memory space for the first and second insurance companys' third-party property specification account information. The company customization module 164 can provide first and second interface data to communicate with the first insurance company's claim processing system 102 or with the second insurance company's claim processing system 102. The first and second insurance company can each be customized with its own claim scoping application 119, and with its own customizations to the location services module 152, localization module 156, materials module 158, and other modules. The company customization module 164 can further provide each of the first and second insurance companies with its own default values for each module.

The company customization module 164 may be configured to cooperate with the dashboard module 142. In this way, a first insurance company may locally or remotely access data that is associated with the first insurance company, and a second insurance company may correspondingly access its own data.

A workflow generation module 166 is configured to generate workflows that administer a claim scoping process for each insurance claim passed into the core system 106. Once generated, the workflow directs actions taken to process the claim. Embodiments of a workflow include a kind of flowchart or “form,” which is presented via a claim scoping software application 119 on a computing device such as the portable computing device 116 associated with a claims adjuster 114. The flowchart comprises a plurality of “nodes” generally associated with flowcharts, such as labels, decision nodes, action nodes, branches, and the like. Many of the nodes (e.g., decision nodes, action nodes) are arranged to receive nodal user input from the developer that is generating the workflow and nodal user input from a claims adjuster that is later executing the workflow.

At its entry point, a workflow directs the gathering of information associated with the insurance claim. At its exit point, the workflow provides one or more loss information reports. Between the entry and the exit point, the workflow nodes direct computing devices and people to cooperatively perform the actions associated with scoping the insurance claim.

These actions to scope the insurance claim will capture data. The data may be accumulated in a raw form in the loss information reports, or the data may be used to generate other data. In one example, a workflow may determine whether or not a third-party property-specific information report has ever been retrieved. If not, the workflow may direct an automatic request be sent from the core system 106 to the third-party computer system to retrieve such a property-specific information report. In another example, the workflow may direct the claims adjuster 114 to perform a certain task such as taking a particular measurement. When the claims adjuster 114 takes the directed measurement the result is entered into a field of the workflow presented on a portable computing device 116. The data retrieved from a property-specific information report or entered by the claims adjuster 114 may be accumulated in a loss information report, or the data used to create other data may be accumulated in a loss information report.

As delivered on the portable computing device 116, a claim scoping application 119 presents workflow tasks in an intuitive, attractive manner. The workflow prompts the claims adjuster 114 for information using predefined questions regarding the loss and, based on the received information, additional predefined questions are asked. The claim scoping application 119 can perform a first level validation of the claims adjuster entries and take action based on predefined rules. Alternatively, or in addition, if the portable computing device 116 is communicatively coupled to the core system 106, the core system 106 can perform a second level validation using, for example, localization module 156.

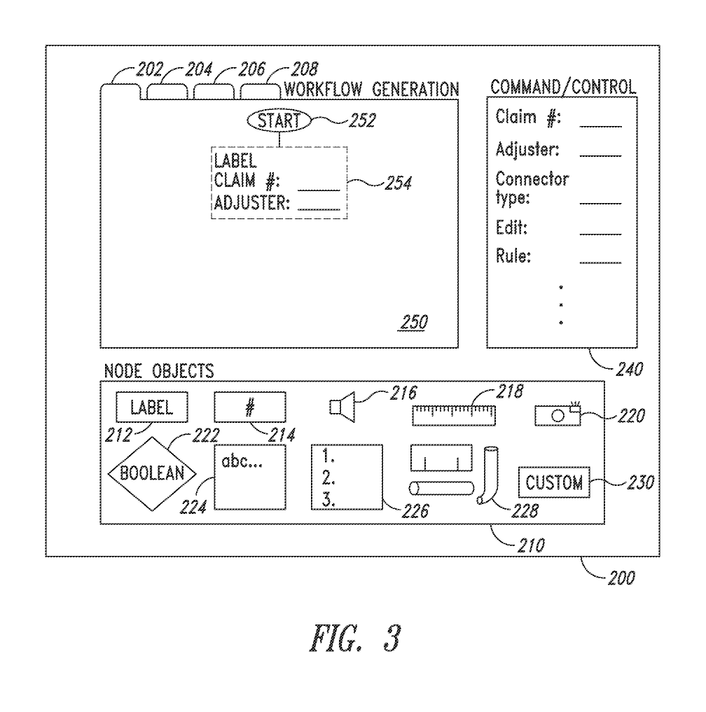

FIG. 3 illustrates a user interface block diagram 200 for a workflow generation module 166. The workflow generation module 166 is directed by the core system 106 and provides a mechanism by which a set of actions are defined to process an insurance claim. The workflow generation module 166 is configured to create, control, edit, and manage workflow processes. The workflows are created in the workflow generation module 166 using a flowchart-based interface and saved to a workflow database. A workflow can be created from scratch, or one or more workflows can be retrieved (e.g., from the workflow database) and used as a template to build a different workflow. These features may permit faster and more efficient workflow generation.

The workflow is represented with one or more processes which may also be referred to as tasks. The processes can be created for any services performed to scope an insurance claim. For example, processes can be created to capture information related to a damaged property structure such as a roof, soffit, gutter, fascia, or some other structure. A process can be created to capture information related to an entire structure (e.g., a house). One process in the workflow can be created from a plurality of other processes.

In the embodiment of FIG. 3, a workflow generation workspace 250 is represented with four pages, 202, 204, 206, 208. More or fewer pages could be represented, and in some cases, pages are added dynamically when a workflow is generated as the pages are needed. Accordingly, a complete workflow may include a single page, a dozen pages, or many more pages. In FIG. 3, each page of the workflow is accessible by identifying (e.g., “clicking on”) a page tab, and as illustrated, a first page 202 of the workflow generation workspace 250 is in the foreground.

In addition to the workflow generation workspace 250 illustrated in FIG. 3, the workflow generation module 166 also presents a node objects store 210 and a command/control area 240. The node objects store 210 presents a group of nodes that can be added to build processes of a workflow. The command/control area 240 presents a set of data, directions, actions, fields, and the like that can be added or are otherwise related to the various nodes. The processes of a workflow are constructed with nodes and with connections between the nodes. Within the workflow generation module 166, the nodes are computational constructs or entities used as basic building blocks of a process, and the nodes are customized to the process by entries in the command/control area 240.

The workflow generation workspace 250, the node objects store 210, and the command/control area 240 are exemplary and not limited by the shapes, positioning, text, numbers, symbols, and other characteristics illustrated. Instead, the embodiments described provide a representative mechanism and toolset useful to create a workflow as described herein.

In the embodiment of FIG. 3, the node objects store 210 includes ten node object types: a label node object 212, a numeric entry node object 214, an audio input node object 216, a measurement node object 218, a photographic image node object 220, a Boolean node object 222, a text entry node object 224, a drop-down list node object 226, a materials node object 228, and a customizable node object 230.

In some embodiments, nodes may be nested together. That is, one node may be constructed with other nodes embedded therein. For example, a numeric entry node 214 may include an embedded audio input node 216. In this construct, the numeric entry node 214 may accept a number input from a keyboard or a number input from an audio device. In another example, a customizable node object 230 may include several numeric entry nodes 214, each of which may include one or more label nodes 212 and an audio input node 216.

A label node object 212 is a node that provides information to a user of the workflow. Generally speaking a label node object 212 does not accept any input. When a label node object is added to the workflow generation workspace 250, the command/control area 240 may include and pre-populate reference information associating the node to a particular workflow and insurance claim identifier. The command/control area 240 may accept a text entry (e.g., by typing input, by voice input, and the like). In FIG. 3, a “START” label 252 is represented in the workflow generation workspace 250. The “START” label 252 is also presented in the user interface workflow embodiment 120 presented on a portable computing device 116 in FIG. 1.

A numeric entry node object 214 is a node used to create one or more fields that accept numeric inputs from a user. When a numeric entry node object 214 is added to the workflow generation workspace 250, the command/control area 240 may be used to customize the numeric entry node. For example, text may be added to inform and instruct the user as to the type of numeric data that will be accepted. Symbols, for example monetary units (e.g., “$”) may be added, units of measure (e.g., mile-per-hour (mph), gallons-per-minute (gpm), pounds (lbs), and others) may be added, hyperlinks that point to network accessible data may be added, reference links to locally accessible data may be added, and other fields may be added or customized. In addition, certain rules may also be added or set forth in the command/control area 240, such as adding numerical boundaries for the entry. For example, if the numeric entry node object 214 is to be used to accept a roof dimension, it may be reasonable to limit the roof dimension to more than 1 foot and to less than 500 feet. Other rules can also be created and applied.

An audio input node object 216 is a node used to create fields that accept audio input from user. When an audio input node object 216 is added to the workflow generation workspace 250, the command/control area 240 may be used to customize the permitted length of audio input. In some embodiments, the command/control area 240 can be used to direct whether or not the audio input will be analyzed with a speech-to-text engine. In some cases, audio is entered only to be listened to. In some cases, the audio input represents substantive data that is to be converted for other processing (e.g., a spoken numeric entry). In still other cases, a speech-to-text engine may be an added service that is included in the workflow generation module 166 processing when the service is paid for.

A measurement node object 218 is included to create fields that accept units of measurement such as feet and inches. When a measurement node object 218 is added to the workflow generation workspace 250, the command/control area 240 may be used to add the particular units (e.g., “ft,” “ft²,” ft³,” “lbs,” and others) and optionally to add a description or expectation of a reasonable measurement. The command/control area 240 may be used to add particular boundaries of the measurement, which are acted on as a claims adjuster 114 performs the actions of the workflow. For example, if the workflow is being used in a claim scoping process and a number such as a roof pitch is entered as more than 45 degrees, the command/control area 240 may have set a boundary to reject the entry and force the claims adjuster 114 to enter a lower, more reasonable roof pitch.

A photographic image node object 220 prompts a claims adjuster 114 to take photo of a component, accessory, structure, or other object of interest such as a roof slope, a dormer, a gable, a particular land feature, or some other object. In some cases, a video may also be directed. When a photographic image node object 220 is added to the workflow generation workspace 250, the command/control area 240 may be used to provide guidance for image or video. The command/control area 240 may further provide tools to edit the photograph or video including cropping, adjusting brightness or contrast, trimming, and adding notations. Other photographic and video editing tools may also be provided.

A Boolean node object 222 can be added to a work flow in areas where a claims adjuster 114 makes decisions or processes the workflow based on a Boolean condition (Yes or No). When a Boolean node object 222 is added to the workflow generation workspace 250, the command/control area 240 may be used to enter suitable text, audio, or other presentable content that asks the question to be answered by the claims adjuster. The command/control area 240 in some cases permits a sequence of nested Boolean node objects 222. Such nested objects may be used to present a “multi-choice” node (e.g., a “case” statement in some software languages). It is recognized, however, that the multi-choice presentation is formed as a sequence of Yes/No decisions of the individual Boolean node objects 222 that are nested together.

A text entry node object 224 is used to create nodes which accept text-based answers. When a text entry node object 224 is added to the workflow generation workspace 250, the command/control area 240 may be used to identify the type or length of text to be entered. In some cases, the command/control area 240 allows entry of exemplary text to help prompt the claims adjuster 114. The command/control area 240 may further provide rules or validations of text that is entered. Such rules and validations may test the length of text entered, perform spell-checking, test content (e.g., keyword) to validate the correctness or appropriateness of the text entry, or the command/control area 240 may perform other functions on text entered. In some embodiments, the command/control area 240 is used to set an indicator to inform a claims adjuster 114 that audio input is accepted, and the command/control area 240 will also perform or otherwise participate in a voice-to-text application.

A drop-down list node object 226 is used to create nodes that present a drop-down list to a claims adjuster 114. Upon encountering a drop-down list node 226 when performing actions of a workflow, the claims adjuster 114 is permitted to select one or more of the items presented. When a drop-down list node object 226 is added to the workflow generation workspace 250, the command/control area 240 may be used to provide the data for the items in the dropped down list.

A materials node object 228 is used to show a list of materials that are relevant at a particular point in a workflow. When a materials node object 228 is added to the workflow generation workspace 250, the command/control area 240 may be used to enter information related to the materials that will be presented and selectable by the claims adjuster 114. The command/control area 240 may interact with the localization module 156, the materials module 158, or other modules of the core system 106 to determine which materials are presented on the list. The analytics module 144 or some other module may provide information to the command/control area 240 to place the materials in a particular order for presentation.

A customizable node object 230 is used to create other nodes that do not have default or template shapes and associated operations. When a customizable node object 230 is added to the workflow generation workspace 250, the command/control area 240 may be used to draw a shape of the customizable node object 230, add presentable content, select input data parameters, and select rules associated with the customizable node object 230.

In some cases, different types of customizable node objects 230 are permitted. A third-party module node is one type of node that can be made accessible via a customizable node object 230. For example, in some cases where a core system 106 includes a property specification module 154 to retrieve property-specific information from a third-party source, the property-specific information may be obtained from the third party by the core system 106. In other cases, however, the decision to obtain the third-party property-specific information can be made by a claims adjuster 114. The customizable node object 230 is one mechanism that can be employed to add a node in a workflow that will request and retrieve the third-party property-specific information. In this case, the node is added and customized within the command/control area 240. The customization may include forming or selecting a suitable icon for the node, adding a network link into the node that points to a selected third-party computing device (e.g., an Internet-accessible world-wide web address), providing logon credentials (e.g., username and password) to access the third-party computing device or providing a mechanism in the node for the claims adjuster to provide the logon credentials, and other parameters to form the request.

A show-component node is another type of customizable node object 230 that may be made accessible via a customizable node object 230. The show-component node is used to display and otherwise describe building materials, insurance company forms, undamaged structures, and a variety of other objects related to an insurance claim scoping process. After the node is added, it may be customized within the command/control area 240. The customization may include forming a “search box” (e.g., a text entry node object 224) so that a claims adjuster 114 may search for a particular component.

Yet one more node that may be made accessible via a customizable node object 230 is an algorithm-node object. The algorithm-node object may be customized to apply a selected algorithm to selected data. The algorithm, data, and other parameters can be identified and defined in the command/control area 240. One exemplary algorithm customizable as an algorithm-node object is a “repair/replace” algorithm. When the node is generated in the workflow and accessed by a claims adjuster 114 during a claim scoping workflow, the algorithm will analyze the loss data previously captured in the loss information report associated with the insurance claim and suggest whether a component or structure should be repaired or replaced. The parameters that factor into such a decision are customizable.

A show-component node is another type of customizable node object 230 that may be made accessible via a customizable node object 230. The show-component node is used to display and otherwise describe building materials, insurance company forms, undamaged structures, and a variety of other objects related to an insurance claim scoping process. After the node is added, it may be customized within the command/control area 240. The customization may include forming a “search box” (e.g., a text entry node object 224) so that a claims adjuster 114 may search for a particular component.

When a workflow is generated, one or more nodes are selected (e.g., “dragged and dropped”) into the workflow generation workspace 250. The nodes in the workflow are coupled together by connectors. As each node in a workflow represents an object having executable actions, a connector directs the sequence of processing from a first node to a second node and from the second node to a third node and so on. The connectors may be represented in the workflow by a solid line, a truncated line, reference letters or numbers, or by some other recognizable object that conveys the sequence of nodal execution.

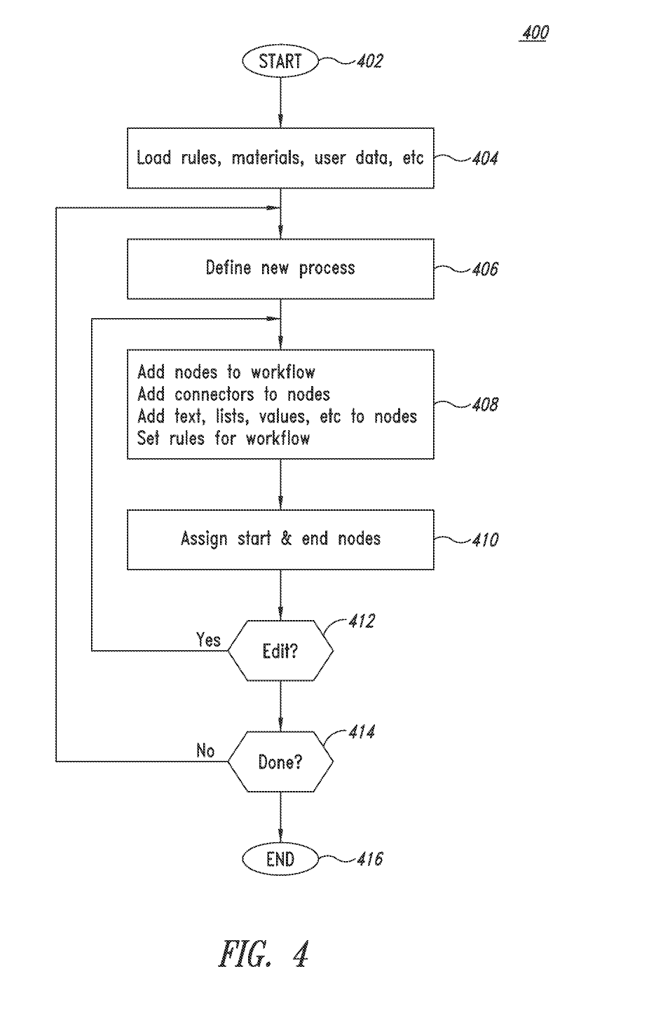

FIG. 4 is a flowchart illustrating generation of an insurance claim workflow 400. The flowchart of FIG. 4 may be understood in view of the user interface block diagram 200 illustrated in FIG. 3, and the user interface workflow embodiment 120 presented on a portable computing device 116 in FIG. 1.

At 402, the generation of the workflow begins.

At 404, various acts of initialization are carried out to load rules, materials, default values, components, and other information to support the workflow generation module 166. The initialization may be performed within the workflow generation module 166, outside the workflow generation module 166, or cooperatively inside and outside of the workflow generation module 166. In some embodiments, initialization acts are performed one time by other modules within the core system 106.

A new process is defined or otherwise identified at 406. The process identifier represents a workflow that will set forth actions to be accomplished in accordance with scoping an underlying insurance claim. Definition of the process identifier within the workflow generation module 166 at 406 will typically cause retrieval or creation of one or more database records associated with an insurance claim or an insurance claim template. For example, if the process at 406 identifies a previously created workflow, then one or more database records associated with the previously created workflow will be retrieved. Alternatively, if the process identified at 406 is previously unknown, then a new set of database entries will be created and associated with the new identifier. Accordingly, the processing at 406 results in identification of one or more data structures associated with a particular insurance claim scoping workflow.

At 408, the workflow generation module 166 of core system 106 presents the user interface having the workflow generation workspace 250, the command/control area 240, and the node objects store 210. Nodes are added to the workflow along with direct or branching connectors between the nodes. Based upon the node type, text, lists, values, events, rules, and other data may also be added to the nodes.

The workflow generation process at 408 is recursive. Any number of new nodes can be added and existing nodes can be modifying as the workflow is generated. Nodes are formed and rules and parameters are added to the nodes. If additional nodes or editing is desired, program flow remains at 408 where more of the constituent parts (e.g., nodes, connectors, rules, and the like) of the workflow are added, edited, or removed. When taken as a whole, the complete set of nodes and their associated parametric information may be presented on computing device as a flowchart. When a claims adjuster 114 performs the acts of the flowchart, the claims adjuster will perform operations to scope an insurance claim and generate sufficient information that the insurance claim can be estimated.

In the workflow generation embodiment illustrated in FIG. 3, a first label node “START” 252 has been added. In addition, a second label node “LABEL” 254 has also been added. The second node “LABEL” includes nested numeric entry and text entry nodes, “CLAIM #:” and “ADJUSTER:” respectively. The labels “START” 252 and “LABEL” 254 are also evident in FIG. 1 in the user interface workflow embodiment 120 presented on a portable computing device 116.

In the embodiment of FIG. 4, start and end nodes are added at 410. In other embodiments, the start and end nodes are added at different points of the workflow generation process. The start node is typically called out as the initialization point for the workflow where database records are retrieved or created, and fields of the database records are populated with known data. The end node is typically called out as the point in a workflow where a loss generation report has accumulated sufficient data for additional processing, for example, estimating.

At 412, the workflow has been substantially generated. When the workflow is deemed complete, then processing will pass to 414. On the other hand, if further editing is desired, program flow will return to 408. If a new workflow is to be modified or generated, program flow is repeated beginning at 406, and if not, processing in the workflow generation module 166 will terminate at 416.

Turning back to FIG. 2, the illustrated core system 106 is illustrated with a claim processing flowchart 170. The flowchart 170 represents the claim scoping process from the perspective of the core system 106.

At 172, one or more claim assignments are passed into the core system 106. The information representing the claims is communicated from claim system 102 via I/O interface 130. Various database records are created or otherwise accessed and information from the claim assignment data is stored. The data retrieved and stored with the core system 106 may be facilitated using storage directly available or onboard the core system 106, or alternatively or in addition, via the remote data repository 126. Within the context of 172, the workflow generation module 166 may be engaged to generate a workflow that will direct a claims adjuster 114 in scoping the claim.

The claim is associated with a claims adjuster at 174. In some cases, the association is automatic. For example, claims with particular characteristics may always be assigned to a particular claims adjuster 114, and so in these cases, the core system may automatically retrieve a stored workflow, populate the workflow with information from the claim assignment, and associate the claim to the particular claims adjuster 114. In other cases, the claims adjuster may be manually associated, for example via a supervisor. In these cases, the dashboard module 142 can convey information regarding claims available for association, workloads and scores of adjusters, and various other criteria. Based on the information presented, the supervisor will associate the claim with a claims adjuster.

In cases where the core system 106 will retrieve property-specific information, the property specification module 154 can be used at 176 to determine if such information is available. The property specification module 154 can be used at 178 to download the property-specific information from a third-party property-specific information system 124, and the information can be accumulated in the appropriate database records (e.g., the loss information report). In other cases, where the determination of whether or not to retrieve property-specific information is left to the claims adjuster 114, one or more nodes will have been placed in the workflow to facilitate the decision and the download.

At 180, the claims adjuster 114 will log on to the core system 106 using appropriate credentials (e.g., username and password, or some other means). The claims adjuster 114 may log directly onto the core system and view data via the dashboard module 142. Alternatively, or in addition, the claims adjuster 114 will log on remotely with a different device such as a portable computing device 116. Amongst other information, the core system 106 will present a listing of claims that are assigned to the claims adjuster 114 for scoping. At 182, the claims adjuster 114 will select one or more assigned claims. Based on the selection of the one or more assigned claims, a respective number of workflows will be communicated at 184 to a portable computing device 116 associated with the claims adjuster 114.

As described herein, the claims adjuster 114 will access a selected workflow using a portable computing device 116. A user interface embodiment of the portable computing device will present the accessed workflow 120 (FIG. 1). Based on the interaction the claims adjuster 114 has with the workflow, the loss site will be visited and various data regarding the loss will be captured in the loss information report.

At 186 in the flowchart 170 of FIG. 2, a loss information report is communicated from the portable computing device 116 to the core system 106. In some cases, the portable computing device 116 will send a loss information report directly to an estimating system 122, and in the same or other cases, the core system at 188 will send information from the loss information report to an estimating system 122.

Various other information processing is also performed in the core system 106 after the loss information report is received. For example, at 190, some or all of the data in a loss information report may be captured as a narrative and stored in a diary formed in internal or external memory. At 192, some or all of the data in a loss information report may be captured and stored in internal memory or external memory (e.g., data repository 126). In yet one more example, at 194, information from the loss information report is communicated to a quality assurance processing service provider such as QA module 146.

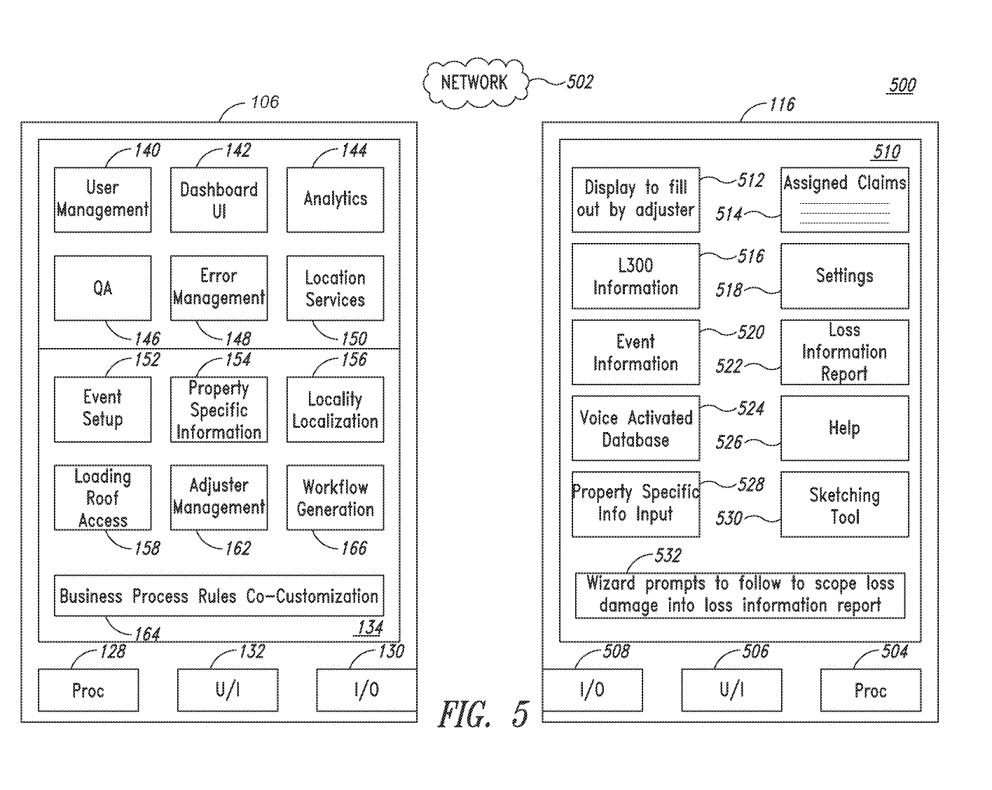

FIG. 5 is an embodiment of an electronic insurance claim information report generation system 500. Embodiments of a core system 106 and a portable computing device 116 are communicatively coupled by a network 502. Certain other devices that participate in the electronic insurance claim information report generation system 500, for example those illustrated in FIG. 2 (i.e., a claim system 102, a third-party property-specific information system 124, an estimating system 122, and a data repository 126), are not shown for simplicity.

The portable computing device 116 includes a processor 504, a user interface 506, an input/output (I/O) interface 508, and a memory 510. Processors, user interfaces, I/O interfaces, and memory of the types represented in the portable computing device 116 of FIG. 5 are discussed in other areas of the disclosure and are applicable here.

In FIG. 2, a claim processing flowchart 170 illustrates portions of a claim scoping process with respect to operations of a core system 106. Cooperatively, other portions of the claim scoping process are illustrated in FIG. 5 with respect to operations of the portable computing device 116. In FIG. 5, memory 510 is configured to store a plurality of software instructions that are executable by processor 504. The software instructions are arranged to carry out the various portions of the claim scoping process within the portable computing device 116. Collectively, the software instructions form the claim scoping application 119 illustrated in FIG. 1.

When the claim scoping application 119 is running on the portable computing device 116, information is presented at 512 to the claims adjuster 114 on a display screen driven by the U/I interface 506. In some cases, the blocks 512-532 of memory 510 are also represented as icons or links on the display screen of the portable device 116. In other cases, the modules 512-532 are representative and accessed in other ways from within the claim scoping application 119.

Execution of the claim scoping application 119 is based on successful entry of credentials (e.g., username and password, personal identification number (PIN), biometric data entry, and the like). Once privilege to the application is granted, the claims adjuster will remain “logged in” until the claims adjuster “logs out,” until a predetermined time without use of the application expires, or based on other criteria. A communicative coupling between the portable computing device 116 and the core system 106 permits data transfer across network 502. In some cases, the claim scoping application 119 at the portable computing device 116 is enabled with a first set of credentials, and access to the core system 106 is enabled with a same or different second set of credentials. The claims adjuster 114 provides the second set of access credentials (e.g., username and password) or in some cases the second set of access credentials are provided by the portable computing device 116. In such a case, the second set of credentials are validated by a user management module 140 of the core system 106.

At 514, the display will present information regarding claims assigned to the claims adjuster 114. One or more claims are selected by the claims adjuster 114, and corresponding workflows are made available. In some cases, the workflows are downloaded directly to the portable computing device 116. In other cases, some or all of the workflow information may be maintained in a memory remote from the portable computing device 116 and such information is accessed via network 502.

A module 532 illustrates a “wizard” that will prompt the claims adjuster 114 to scope the loss damage into a loss information report. The wizard can take any form including the presentation of interactive multimedia content to direct operations of the claim scoping process. For example, as discussed in the embodiment of FIG. 1, a user interface 506 embodiment of the workflow 120 directs the actions of the claims adjuster 114 with respect to the loss. The workflow is represented as a flowchart in FIG. 1, but other presentations are contemplated including audio prompts, video presentation, and others. It is understood that the workflow guides the claims adjuster 114 to perform the claim scoping tasks in a preferred sequence, but the claims adjuster 114 in some circumstances is permitted to change the order of tasks performed.

As the claims adjuster 114 progresses through the workflow, many aspects of the claim scoping application 119 are made available to assist the claims adjuster 114 efficiently scope the claim. These aspects include optional modules 516-530, some or all of which may be included in various embodiments.

An L300 information module 516, when accessed, allows the claims adjuster 114 to retrieve general information about the claim as presented on an L300 insurance report. A claims adjuster 114 can access L300 information and other information associated with an insurance claim while executing the claim scoping application 119 and progressing through a workflow without altering or disrupting the workflow. Other information may be included as well. For example, in some embodiments, the general claim information of the L300 report is presented along with adjuster notes and specific details related to the loss. If the loss includes a damaged roof, some of the information may be a roof drawing from a claims adjuster sketch or from a third-party property-specific information provider, and added details entered by the claims adjuster 114, such as the age of the roof, the number of stories of the structure or additional exterior elevation details, the number of roof layers, the roof type, the roof pitch, whether a claims adjuster has been on roof or not or whether a roof sight is required, whether or not there is collateral damage consistent with that reported, subrogation details, repair/replace information such as covered damage, brittleness test results, and a list of slopes with scope information, pictures and videos.

A settings module 518 allows a claims adjuster 114 to customize certain display features of the claim scoping application 119. For example, the claims adjuster 114 can adjust screen brightness (e.g., sunny day, nighttime, rainy day, and the like), color scheme, icon sizes, menu positioning, and the like.

The claim scoping application 119 can access event information at 520 before, during, or after workflow processing. A list of all events assigned to the claims adjuster 114 is optionally presentable, and details of each event including rules, needed skills, and other aspects of the event are typically available. The event information is sometimes captured and communicated to the portable computing device 116 during a communicative coupling of the portable computing device 116 and the core system. In addition or in the alternative, the event information may be dynamically accessed from the event setup module 152 of the core system 106 by portable computing device 116.

A loss information report can be automatically communicated to the core system after the workflow is completed. Interim versions of the loss information report may be sent to the core system 106 when certain milestones are reached in the workflow. For example, when a first threshold level of information is entered, a version of the loss information report may be sent, and when a second threshold level of information is entered, a second version of the loss information report may be sent and so forth. In some embodiments, an “estimation” version of the loss information report is automatically sent to an estimating system. If the portable computing device is unable to communicate with an external system, which may happen for example in areas where wireless connectivity is limited or absent, the claim scoping application 119 stores the data for later submission when connectivity is restored.

During the scoping process, while the workflow is ongoing, the claims adjuster 114 is permitted to access the loss information report at 522. In some cases, incomplete fields of the loss information report are highlighted in one way or another, such as by coloring a background, changing a text color, blinking an indicator, or highlighting the fields in the loss information report. After viewing an incomplete loss information report, the claims adjuster 114 may return to carrying out tasks of an unfinished workflow (e.g., via the wizard at 532).

A voice recognition feature allows a claims adjuster to “speak” notes, diary entries, narratives, measurements, materials, and the like rather than typing them. The voice recognition feature may be coupled to voice activated database (VAD) at 524 to timely process the spoken information.

A help feature is accessible via the claim scoping application 119 at 526. The help feature may publish contact information to various network-path services. For example, the help feature may recognize impending trouble and automatically perform acts to inform, correct, and possibly mitigate damage from the failed actions. Documentation may be available, for example, including a system manual. The system manual may provide a how-to interactive manual that allows the claims adjuster 114 to search or look up in an index on how to use the claims scoping application 119, how to file and view a status report regarding a filed support ticket, and in some cases, how to integrate voice recognition technology with the voice activated database (VAD). In some cases where a VAD system is integrated or otherwise available, the claims adjuster 114 is able to open a support ticket using the VAD and direct that a transcribed message be placed in a ticket system. In this case, the claims adjuster 114 may further access available replies on the ticket system. The claims adjuster 114 may receive a notification from the support system when support tickets are opened and when the status of a ticket is changed.

A property-specific information input module at 528 and a sketching tool module at 530 may be used cooperatively in some cases and separately in other cases. In cases where the location services module 150 of the core system 106 retrieves property-specific information from a third party, the information may be communicated to the portable computing device 116. If changes or comments are to be added by the claims adjuster 114 to the property-specific information from the third party, the information may be added using the sketching tool at 530. Alternatively, if no third-party property-specific information is available, the sketching tool model at 530 may be used by the claims adjuster 114 to draw representative images of the loss site, damages, and other related images.

When conducting a claim scoping process, the claims adjuster 114 will provide one or more sketches of the loss site, which help to visually describe the loss. For example, if the loss relates to roof damage, the claims adjuster 114 may sketch the entire roof as a whole and various areas of the roof from different perspective views. After the roof is sketched, the claims adjuster 114 will identify each slope by going over each drawn line and providing a slope name. This allows for the system to “break up” the roof that was sketched and use the information for the scope slope selection. The claims adjuster 114 can enter measurements related to each side of the roof and each slope. The sketching tool or other functions of the claim scoping application 119 can then automatically perform calculations on the area drawn.

When the sketching tool is accessed at 530, a grid workspace is presented on the display device. Each “square” of the grid represents a physical space and, accordingly, the dimensions of each representative square can be changed (i.e., scaled). Certain embodiments of the sketching tool permit the squares of the grid to be scaled from 1 square foot per grid square to 10 square feet per grid square. The claims adjuster 114 can choose the grid scale factor that is appropriate to the structure being sketched. Although the present exemplary embodiment is directed to an insurance claim for a damaged roof, sketches of other loss types such as other parts of a building, automobiles, personal property, and more are also contemplated.

Lines can be drawn by the claims adjuster 114 within the grid workspace using a “straight line” tool. In addition, geometric shapes having straight lines (e.g., rectangles, triangles) can be chosen by the claims adjuster 114 and added to the grid workspace. If the chosen scale is changed, the entered dimensional measurements and shapes will be automatically resized.

After a certain number of measurements are entered, the sketching tool at 530 will calculate the area of the sketched and identified shapes (e.g., slope). In some embodiments, the sketching tool at 530 may highlight (e.g., by color, by sound, by flashing icons or lines) information that is expected to be populated with measurements or other data from the claims adjuster 114.

The sketching tool at 530 will provide a variety of “tools” used to create sketches. For example, a freehand “pencil,” a brush, a color selection palette, an eraser, a variety of geometric shapes (e.g., a straight line, an arch, a circle, a square, an ellipse, arrows, check marks, and the like) are some of the available tools. The shapes placed in the sketch may be modified with, for example, a color fill (e.g., bucket), a text tool, and the like. The shapes can also be modified to include a “drag canvas” feature (e.g., to move an entire background), a rotation feature, and a zoom-in/zoom-out feature.

In some cases, the sketching tool at 530 may begin with a certain stored template. Some embodiments include a plurality of stored templates of different parts of houses, for example, as well as pre-defined roof layout templates. The templates can be modified by the claims adjuster 114 as needed.

The workflow presented by the claim scoping application 119 via the wizard at 532 may optionally include several additional features to improve the efficiency of the claims adjuster 114. For example:

Data is saved dynamically as the claims adjuster 114 moves through the workflow, even if the claim scoping application 119 is suspended or terminated. In some cases, the data is automatically or manually uploaded to the core system 106 while the workflow is in progress.

The claims adjuster 114 can reopen a workflow to add additional information or edit a loss information report, even after the report has been communicated. New information in a workflow or loss information report may be suitably identified as “new” or “updated.” The new or updated information may be color coded, presented in a different font or with different attributes, or distinguished in other ways.

Prompted or unprompted notes can be added to a workflow by a claims adjuster 114. Access to the notes can be restricted based on user credentials or privileges administered, for example, by user management module 140. Notes can be written, spoken, photographed, or otherwise recorded.

First level validation of data performed locally on the portable computing device may include materials used, bounds-checking on numbers entered (e.g., measurements), spelling of names, addresses, and the like against data prepopulated on the workflow. Second level validation of data can be performed by the core system 106 with the localization module 156, the error log module 148, and other modules. When the portable computing device 116 is communicatively coupled to the core system during processing of a workflow, the first and second levels of validation may occur dynamically and concurrently.

In some embodiments, the claim scoping application 119 is configured to update the external claim processing system 102. The update may be manual or automatic. The claim scoping application 119 may provide the update directly to the claim processing system, for example via an Internet connection, or the claim scoping application 119 may provide the update to the core system 106, and the core system 106 communicates the update to the claim processing system 102.

The claims adjuster 114 may use the claim scoping application 119 to generate diary entries that catalog the work of the claims adjuster 114. In some embodiments, the claim scoping application 119 presents a link or other information identifying each workflow that is not complete. Each workflow has an associated diary with entries either filled out or entries to be filled out by the claims adjuster 114. The claims adjuster 114 is permitted to “speak” the diary entries. Known information that is replicated in a diary entry is retrieved by the claim scoping application 119 and pre-populated or dynamically populated in the diary entry.

A feature of the claim scoping application 119 permits searching of assigned claims, events, pending and completed workflows, property addresses, loss-types, and other information. The search utility can in some cases accept a variety of input such as typing, touch-screen entries, spoken words, and others. In one embodiment, a current location is manually entered or automatically captured (e.g., GPS coordinates, wireless radio location determination), and the position is used locally or in conjunction with a location services module 150 of the core system 106 to identify an assigned insurance claim or an associated work flow.

FIGS. 1, 2, and 4 include data flow diagrams illustrating processes that may be used by embodiments of the new claim scoping system described herein. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

The figures in the present disclosure illustrate portions of one or more non-limiting computing device embodiments. The computing devices include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

Processors, as described herein, include central processing units (CPU's), microcontrollers (MCU), digital signal processors (DSP), application specific integrated circuits (ASIC), and the like. The processors interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, embodiments describe software executable by the processor and operable to execute certain ones of the method acts.

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to be executed by a processor.

The computing devices illustrated herein further include operative software found in a conventional computing device such as an operating system, software drivers to direct operations through the I/O circuitry, networking circuitry, and other peripheral component circuitry. In addition, the computing devices include operative application software such as network software for communicating with other computing devices, database software for building and maintaining databases, and task management software where appropriate for distributing the communication and/or operational workload amongst various processors. In some cases, the computing device is a single hardware machine having the hardware and software listed herein, and in other cases, the computing device is a networked collection of hardware and software machines working together in a server farm to execute the functions of one or more embodiments described herein. Some aspects of the conventional hardware and software of the computing device are not shown in the figures for simplicity.

When so arranged as described herein, each computing device is transformed from a generic and unspecific computing device to a combination device comprising hardware and software configured for a specific and particular purpose.

Database structures as described herein may be formed in a single database or multiple databases. In some cases hardware or software storage repositories are shared amongst various functions of the particular system or systems to which they are associated. A database may be formed as part of a local system or local area network. Alternatively, or in addition, a database may be formed remotely, such as within a “cloud” computing system, which would be accessible via a wide area network or some other network.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, devices such as a claim processing system 102, a core system 106, a portable computing device 116, an estimating system 122 and other devices communicate over a network 502 (FIG. 5). The network may involve an Internet connection or some other type of local area network (LAN) or wide area network (WAN). Non-limiting examples of structures that enable or form parts of network 502 include, but are not limited to, an Ethernet, twisted pair Ethernet, digital subscriber loop (DSL) devices, wireless LAN, WiFi, Worldwide Interoperability for Microwave Access (WiMax), or the like.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic insurance claim scoping system, comprising:
a processor;
an input/output interface coupled to the processor and configured to accept data for processing by the processor and configured to communicate data processed by the processor; and
a memory associated with the processor, the memory including software instructions executable by the processor, the software instructions arranged to direct operations of the electronic insurance claim scoping system via a plurality of modules, the operations including:
receiving insurance claim assignments from a first external system;
for each received insurance claim assignment, checking a second external system for availability of property-specific information associated with the respective received insurance claim assignment;
automatically downloading available property specification information;
accepting an adjuster log-in from a remote device associated with the adjuster;
selecting an insurance claim assigned to the logged-in adjuster;
communicating information associated with the selected insurance claim to the remote device associated with the adjuster;
accepting a loss information report associated with the selected insurance claim, the loss information formed via a scoping application executed on the remote device associated with the adjuster;
the plurality of modules including:
a user management module, the user management module configured to manage individual users of the electronic insurance claim scoping system, the individual users organizable into a plurality of user permission groups; and
a dashboard module, the dashboard module configured to display information to a first user of the electronic insurance claim scoping system based on a membership designation of the first user in at least one of the plurality of user permission groups.

2. The electronic insurance claim scoping system of claim 1 wherein the plurality of modules further includes:
a location services module, the location services module configured to:
receive geographic location information from the remote device associated with the logged-in adjuster; and
automatically locate an insurance claim number of an insurance claim associated with the geographic location information.

3. The electronic insurance claim scoping system of claim 2 wherein the location services module is further configured to:
automatically locate a map of an area associated with the geographic location information.

4. The electronic insurance claim scoping system of claim 2 wherein the location services module is further configured to:
associate the geographic location information with information received from the remote device associated with the logged-in adjuster.

5. The electronic insurance claim scoping system of claim 1 wherein the plurality of modules further includes:
a workflow generation module, the workflow generation module configured to generate a workflow associated with the selected insurance claim, the workflow displayable as a flowchart having a plurality of node objects coupled together by a plurality of connectors, the workflow configured to direct the logged-in adjuster to perform actions associated with the selected insurance claim.

6. The electronic insurance claim scoping system of claim 5 wherein at least some of the plurality of node objects of the workflow are configured to store data linked to the respective node object.

7. The electronic insurance claim scoping system of claim 5 wherein the workflow generation module configured to generate the workflow associated with the selected insurance claim is further configured to:
present a flowchart-based interface;
permit the first user to select at least two node objects from a pool of template node objects, the pool of template node objects including:
a label node object configurable to present an instruction;
a Boolean node object configurable to identify an available plurality of next node objects, a selection of a next node object based on at least one Boolean condition;
a numeric answer node object, the numeric answer node object configurable to accept numeric nodal user input; and
a text answer node object, the text answer node object configurable to accept textual nodal user input.

8. The electronic insurance claim scoping system of claim 7 wherein the pool of template node objects further includes:
an audio answer node object, the audio answer node object configurable to accept audio nodal user input; and
a take-photo node object, the take-photo node object configurable to present a prompt to a user of the remote device, the prompt requesting a digital image nodal input, the take-photo node object further configurable to accept a digital image.

9. The electronic insurance claim scoping system of claim 7 wherein the pool of template node objects further includes:
a list of values node object, the list of values node object configurable to present a drop down list and further configurable to accept drop down list selection nodal user input;
a measurement node object, the measurement node object configurable to accept measurement nodal user input, the measurement nodal user input conforming to a selected units of measure; and
a load material list node object, the load material list node object configurable to present a list of materials and further configurable to accept list selection nodal user input, the list selection nodal user input identifying at least one material on the load material list.

10. A non-transitory computer readable medium having computer executable instructions thereon that, when executed, cause a processor to create, control, or manage an insurance claim workflow, comprising:
presenting a flowchart-based interface;
accepting user input selecting at least two node objects from a pool of template node objects, the pool of template node objects including:
a label node object configurable to present an instruction;
a Boolean node object configurable to identify an available plurality of next node objects, a selection of a next node object based on at least one Boolean condition;
a numeric answer node object, the numeric answer node object configurable to accept numeric nodal user input; and
a text answer node object, the text answer node object configurable to accept textual nodal user input;
accepting user input positioning the selected node objects on a workspace;
accepting user input associating presentable information with at least one of the selected node objects, the presentable information linked to the at least one of the selected node objects and presentable when the insurance claim workflow is displayed;
accepting user input coupling a plurality of nodes via at least one connector object;
displaying the insurance claim workflow as a flowchart having the at least two selected node objects coupled via the at least one accepted connector object; and
associating the insurance claim workflow with an insurance claim record.

11. The non-transitory computer readable medium of claim 10 wherein the pool of template node objects further includes:
an audio answer node object, the audio answer node object configurable to accept audio nodal user input;
a take-photo node object, the take-photo node object configurable to present a prompt to a user, the prompt requesting a digital image nodal input, the take-photo node object further configurable to accept a digital image;
a list of values node object, the list of values node object configurable to present a drop down list and further configurable to accept drop down list selection nodal user input;
a measurement node object, the measurement node object configurable to accept measurement nodal user input, the measurement nodal user input conforming to a selected unit of measure; and
a load material list node object, the load material list node object configurable to present a list of materials and further configurable to accept list selection nodal user input, the list selection nodal user input identifying at least one material on the load material list.

12. The non-transitory computer readable medium of claim 10 having computer executable instructions thereon that, when executed, cause the processor to create, control, or manage the insurance claim workflow, further comprising:
communicating the insurance claim workflow to a remote computing device;
receiving an updated insurance claim workflow from the remote computing device, the updated insurance claim workflow having information linked to at least one of the selected node objects; and
processing the linked information.

13. An electronic insurance claim scoping method, comprising:
instantiating a scoping software application on a portable computing device;
retrieving a record identifying an insurance claim assigned to a first user of the portable computing device wherein the insurance claim is directed to damage to an improvement located on a subject real property;
retrieving a workflow associated with the record, the workflow displayable as a flowchart having a plurality of node objects coupled together by a plurality of connectors, the workflow configured to direct the first user to perform actions associated with the insurance claim;
populating a first plurality of entries of the workflow;
displaying on a display device of the portable computing device at least a portion of the workflow;
accepting workflow user input, the workflow user input configured to identify a node object of the workflow;
accepting nodal user input, the nodal user input including information regarding the subject real property;
linking the nodal user input with the identified node object; and
communicating the workflow to a remote computing server.

14. The method of claim 13, comprising:
authenticating the first user of the portable computing device based on an insurance adjuster identification record.

15. The method of claim 13, comprising:
generating a scripted voice prompt with a speech synthesis engine, the scripted voice prompt corresponding to an audio answer node object of the workflow, the scripted voice prompt requesting information from the first user; and
playing the scripted voice prompt via an audio output apparatus of the portable computing device.

16. The method of claim 15 wherein the scripted voice prompt is generated according to a stored template.

17. The method of claim 15, comprising:
generating scripted voice prompts with a speech synthesis engine, the scripted voice prompts corresponding to an audio answer node object of the workflow, the voice prompts requesting information from the first user; and
accepting additional nodal user input in response to the scripted voice prompt, the additional nodal user input including at least one of:
audio input captured with an audio input apparatus of the portable computing device,
electronic image input captured with a camera apparatus of the portable computing device, and
text input captured with a text input apparatus of the portable computing device.

18. The method of claim 13, comprising:
importing at least one electronic image file, the electronic image file representing a digital image of at least some portion of the property;
passing the at least one electronic image file to a display device associated with the portable computing device; and
linking the at least one electronic image file to the identified node object of the workflow.

19. The method of claim 13 wherein the plurality of node objects are selected from a pool of node objects, the pool comprising:
a label node object configured to present an instruction and further configured to not accept nodal user input;
a Boolean node object configured to identify an available plurality of next node objects, a selected next node object based on at least one Boolean condition;
a numeric answer node object, the numeric answer node object configured to accept numeric nodal user input;
a text answer node object, the text answer node object configured to accept textual nodal user input;
an audio answer node object, the audio answer node object configured to accept audio nodal user input;
a list of values node object, the list of values node object configured to present a drop down list and further configured to accept drop down list selection nodal user input;
a measurement node object, the measurement node object configured to accept measurement nodal user input, the measurement nodal user input conforming to a selected units of measure;
a load material list node object, the load material list node object configured to present a list of materials and further configured to accept list selection nodal user input, the list selection nodal user input identifying at least one material on the load material list; and
a take-photo node object, the take-photo node object configured to present a prompt to a user of the portable computing device, the prompt requesting a digital image nodal input, the take-photo node object further configured to accept a digital image.

20. The method of claim 13, comprising:
performing an automated cost estimate based on the workflow.
